(19) United States
(12) Patent Application Publication
(10) Pub. No.: US 2014/0269372 A1
(43) Pub. Date: Sep. 18, 2014

(54) SYSTEM AND METHOD FOR JITTER MITIGATION IN TIME DIVISION MULTIPLE ACCESS (TDMA) COMMUNICATIONS SYSTEMS

(71) Applicant: Hughes Network Systems, LLC, Germantown, MD (US)

(72) Inventors: Satyajit ROY, Gaithersburg, MD (US); Guy MONTGOMERY, Potomac, MD (US); Jeffrey BIBER, Sterling, VA (US)

(73) Assignee: Hughes Network Systems, LLC, Germantown, MD (US)

(21) Appl. No.: 13/893,553

(22) Filed: May 14, 2013

Related U.S. Application Data
(60) Provisional application No. 61/801,312, filed on Mar. 15, 2013.

(51) Int. Cl. H04L 12/26; H04L 12/875; H04L 1/20

(52) U.S. Cl. CPC H04L 43/087; H04L 1/205; H04L 47/56
USPC 370/252

(57) ABSTRACT

A TDMA jitter buffer includes a receiver, a processor and a comparator. The receiver can receive a data transmission signal via a channel of a communications system, and can receive one or more delay factors measured at a transmission end of the channel, wherein each delay factor is associated with a respective data packet. The processor can queue each of the data packets that is associated with a delay factor in a respective one of one or more jitter buffers. The comparator can perform a comparison, for each data packet that is associated with a delay factor, between the respective delay factor and a predetermined latency parameter. The processor can further release each data packet that is queued in one of the jitter buffers based on the comparison between the respective delay factor associated with the data packet and the predetermined latency parameter.

### RELATED APPLICATIONS

This application claims the benefit of the earlier filing date under 35 U.S.C. §119(e) of U.S. Provisional Application Ser. No. 61/801,312 (filed 15 Mar. 2013), titled “SYSTEM AND METHOD FOR JITTER MITIGATION IN TIME DIVISION MULTIPLE ACCESS (TDMA) COMMUNICATIONS SYSTEMS,” the entirety of which is incorporated herein by reference.

### BACKGROUND

The present invention generally relates to the reduction or removal of packet jitter in Time Division Multiple Access (TDMA) telecommunication systems including Multi-Frequency TDMA (MF-TDMA) systems.

Time Division Multiple Access (TDMA) is a channel access method for shared medium telecommunication networks. It allows several users to share the same frequency channel by dividing the signal into different time slots. The users transmit in rapid succession, one after the other, each using its own time slot. This allows multiple stations to share the same transmission medium (e.g., radio frequency channel) while using only a part of its channel capacity. TDMA is used in the digital 2G cellular systems such as Global System for Mobile Communications (GSM), IS-136, Personal Digital Cellular (PDC) and iDEN, and in the Digital Enhanced Cordless Telecommunications (DECT) standard for portable phones. It is also used extensively in satellite systems as well as combat-net radio systems and PON networks for upstream traffic from premises to the operator. For satellite networks, MF-TDMA is the dominant technology because it provides the most bandwidth and the greatest overall efficiency and service quality, while also allowing the dynamic sharing of that bandwidth among many (tens of thousands) of transmitters in a two-way communication mode.

Unlike a Single Carrier Per Channel (SCPC) system, a system employing TDMA is more prone to producing packet jitter. In an SCPC system user packets can be transmitted as soon as they arrive for transmission whereas in a TDMA system there could be a variable temporal gap between when packets arrive and when time slots are allocated for the terminal to send those packets. The variable gaps produced manifest themselves as packet jitter. This is true irrespective of a regularly arrived packet stream or an irregular packet stream. Packet jitter can be undesirable in certain applications, especially voice applications where the voice quality can be noticeably adversely affected by it. It is important to maintain good service quality in a telecommunications network and control of jitter and latency is a very important part of that. Jitter and latency measurements are often used in Mean Opinion Score (MOS) algorithms to provide metrics for voice quality in voice applications.

Where there is a regular packet stream to be transmitted, jitter buffers employ a mechanism which can effectively reduce or remove the jitter. However, the jitter buffer mechanism is not suited to cases where the packet stream consists of packets arriving irregularly.

What is needed, therefore, is an approach for mitigating/eliminating jitter in applications where irregular packet data streams are transmitted over a TDMA communications link.

### SOME EXAMPLE EMBODIMENTS

The present invention advantageously addresses the foregoing requirements and needs, as well as others, by providing systems and methods for mitigating/eliminating jitter in applications where irregular packet data streams are transmitted over a TDMA communications link.

In accordance with example embodiments of the invention, an apparatus comprises a receiver, a processor and a comparator. The receiver receives a data transmission signal via a channel of a communications system, and receives one or more delay factors measured at a transmission end of the channel, wherein each delay factor is associated with a respective data packet. The processor queues each of the data packets that is associated with a delay factor in a respective one of one or more jitter buffers. The comparator performs a comparison, for each data packet that is associated with a delay factor, between the respective delay factor and a predetermined latency parameter. The processor further releases each data packet that is queued in one of the jitter buffers based on the comparison between the respective delay factor associated with the data packet and the predetermined latency parameter.

In accordance with further embodiment, each delay factor may comprise a delay measurement based on a time that the respective data packet is received by a transmitter at the transmission end of the channel, and a time that the respective data packet is transmitted over the channel. Further, according to another embodiment, the predetermined latency parameter may comprise a delay value reflecting an approximate maximum acceptable latency for the data packets queued in the one or more jitter buffers, and wherein the processor releases each queued data packet in accordance with a timestamp, wherein the timestamp is determined based on the comparison such that a total time that the packet remains in the jitter buffer plus the respective delay factor does not exceed the approximate maximum acceptable latency for the data packet. Additionally, according to yet a further embodiment the predetermined latency parameter comprises one of a configurable system parameter set based on a length of a transmission frame and a trained parameter that is determined based on a relative maximum data packet delay experienced during a period of system operation.

Still other aspects, features, and advantages of the present invention are readily apparent from the following detailed description, which illustrates and describes a number of particular example embodiments and implementations, including the best mode contemplated for carrying out the present invention. The present invention is also capable of further embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a TDMA satellite system capable of employing an approach for mitigating or eliminating jitter, in accordance with example embodiments;

FIG. 2 illustrates a transmission timing diagram of the system of FIG. 1 for a data packet stream in which data packets are arriving at regular intervals;

FIG. 3 illustrates a block diagram depicting transmission of the packet stream of FIG. 2 within the system of FIG. 1, in accordance with example embodiments;

FIG. 4 illustrates an example transmission timing diagram of the system of FIG. 1 for a packet stream wherein data packets are arriving at irregular intervals;

FIG. 5 illustrates a diagram of irregular data packet streams presented for transmission over an end-to-end TDMA satellite path, in accordance with example embodiments;

FIG. 6 illustrates a block diagram of a transmission system, in accordance with example embodiments;

FIG. 7 illustrates a block diagram of a receiving system, in accordance with example embodiments;

FIG. 8 illustrates a transmission timing diagram for an irregular data packet stream presented to the system of FIG. 6, in accordance with example embodiments;

FIG. 9 provides a table illustrating arrival times and intervals between packets of an irregular packet stream measured at various points in the systems of FIGS. 6 and 7, with a reference delay parameter set to equal a frame period of 45 milliseconds, in accordance with example embodiments;

FIG. 10 provides a table illustrating arrival times and intervals between packets of an irregular packet stream measured at various points in the systems of FIGS. 6 and 7, with a reference delay parameter set at 40 milliseconds, in accordance with example embodiments;

FIG. 11 illustrates a block diagram depicting a multiple jitter buffer system, employing two jitter buffers on the basis of multiple reference delay parameters, in accordance with example embodiments;

FIGS. 12A and 12B illustrate flow charts of a method for employing an approach for mitigating or eliminating jitter, in accordance with example embodiments; and

FIG. 13 illustrates a block diagram depicting of a chip set that can be utilized in implementing an approach for mitigating or eliminating jitter, in accordance with example embodiments.

### DETAILED DESCRIPTION

Systems and methods for mitigating/eliminating jitter in applications where irregular packet data streams are transmitted over a TDMA communications link, are herein described.

FIG. 1 illustrates a TDMA satellite system capable of employing an approach for mitigating or eliminating jitter, in accordance with example embodiments. With reference to FIG. 1, system 100 includes a TDMA slot assigner 104, a transmitter 108, a transmission antenna 112, a satellite 114, a receiving antenna 116, a receiver 120 and a jitter buffer 124. The transmitter 108 and the TDMA slot assigner 104 represent components of a terminal transmission section 101 of a satellite terminal at the transmission end of the system 100. The receiver 120 and the jitter buffer 124 represent components of a terminal receiver section 111 of a satellite terminal at the receiving end of the system 100. TDMA slot assigner 104 is arranged to receive packet stream 102 and to output slot-assigned packet stream 106. Transmitter 108 is arranged to receive slot-assigned packet stream 106 and output RF signal 110 to transmission antenna 112. Transmission antenna 112 is arranged to transmit RF signal 110 over-the-air on uplink 130 to satellite 114. Receiving antenna 116 is arranged to receive downlink 132 over-the-air from satellite 114 and output RF signal 118. Receiver 120 is arranged to receive RF signal 118 and output packet stream 122 to jitter buffer 124, and jitter buffer 124 is arranged to output packet stream 126.

Packet stream 102 is the input data to system 100 and is the data to be transmitted over the satellite in order for it to be received at the far end of the telecommunications link. In this example, packet stream 120 is a serial stream of packets with the packets starting at regular intervals. Packet stream 102 is not synchronized with the TDMA frame timing when it enters system 100. TDMA slot assigner 104 assigns packets of packet stream 102 to TDMA time slots in the TDMA frame and inserts packets of packet stream 102 in assigned TDMA time slots to produce slot-assigned packet stream 106. In other examples, TDMA slot assigner 104 may be simultaneously assigning and inserting other user data and overhead information to TDMA time slots for satellite transmission. Transmitter 108 provides modulation and forward error correction (FEC) encoding for slot-assigned packet stream 106 and conversion to radio frequencies to produce RF signal 110. RF signal 110 is transmitted over-the-air by transmission antenna 112. Slot-assigned packet stream 106 contains the data packets of packet stream 102 resynchronized to the TDMA frame for transmission. In other examples, slot-assigned packet stream 106 may also include other user data and overhead data in addition to the data packets originating from packet stream 102.

RF signal 110 is a radio frequency signal which is the result of transmitter 108 taking slot-assigned packet stream 106 and applying modulation, FEC encoding and frequency upconversion. Satellite 114 receives the radio frequency signal from transmit antenna 112 and converts it to a different radio frequency for re-transmission down to the earth. Receiving antenna 116 converts over-the-air signals received from satellite 114 to an RF signal compatible with receiver 120. Receiver 120 converts RF signal 118 to a data packet stream by applying downconversion, demodulation and decoding. Jitter buffer 124 removes jitter from the data packet stream. RF signal 118 is the RF signal 110 after being transmitted over satellite 114 and received through receiving antenna 116. Packet stream 122 contains the same packet data as slot-assigned packet stream 106. Packet stream 122 has the same timing as slot-assigned packet stream 106 with packets appearing in assigned TDMA time slots.

The timing of the packets of packet stream 122 being according to assigned TDMA time slots means that the spacing in time of packets will be different from the regular spacing of packet stream 102. The difference in packet spacing is known by the term packet jitter. Packet jitter is removed by jitter buffer 124 by removing the difference in packet spacing. This is done by inputting packets of packet stream 122 into jitter buffer 124 as they arrive with TDMA time slot timing, then outputting packets of packet stream 122 from jitter buffer 124 using the same regular packet spacing as packet stream 102, to produce packet stream 126.

According to the illustrated embodiments, transmitter 108 and transmission antenna 112 are shown to be a satellite link transmitter and a satellite dish respectively, but in other examples may be any components used to transmit a packet stream to a receiving station, non-limiting examples of which include a cellular transmitter and antenna, a WiFi or Bluetooth transmitter and antenna, a terrestrial microwave link transmitter and antenna or a device for wired telecommunications transmission. Similarly, in this example, receiving antenna 116 and receiver 120 are shown to be a satellite dish and a satellite link receiver respectively, but in other example may be any components used to receive a packet stream from a transmitting station, non-limiting examples of which include a cellular receiver and antenna, a WiFi or Bluetooth receiver and antenna, a terrestrial microwave link receiver and antenna or a device for wired telecommunications reception.

FIG. 2 illustrates a transmission timing diagram of the system of FIG. 1 for a data packet stream in which data packets are arriving at regular intervals. As shown in FIG. 2, the diagram 200 includes an X-axis 202, a Y axis 204, a TDMA frame 206, a TDMA frame 208, a TDMA frame 210, a TDMA frame 212, a TDMA data burst 214, a TDMA data burst 216, a TDMA burst 218, a TDMA burst 220, an input packet 222, an input packet 224, an input packet 226, an input packet 228, an output packet 230, an output packet 232, an output packet 234 and an output packet 236. X-axis 202 represents time and y-axis 204 represents timing events. In this example, TDMA frames 206, 208, 210 and 212 are arranged to be 45 milliseconds in length and consecutive in time. TDMA data bursts 213, 216, 218 and 220 are arranged to occur shortly after the start of each TDMA frame.

In a TDMA link, the transmit channel is divided into time periods called frames. TDMA systems described here have a frame period of 45 milliseconds (ms). The frame timing is broadcast throughout the network so that all terminals in the network can synchronize to it. The frames are further divided in into time periods called slots. In a MF-TDMA system, there are multiple channels at different frequencies all synchronized to the frame timing, each channel being divided into slots. The channels and their slots form a pool of opportunities for terminals to transmit a short burst of data. The terminals are assigned channels and slots for transmission using information received from a centralized processor at a Network Operations Center (NOC). This information is conventionally called the Network Plan. The Network Plan ensures that all terminals in the network are assigned channels and slots such that they do not transmit data bursts on the same channel frequency at the same time. The Network Plan can be static or it can change dynamically according to changing bandwidth requirements over time.

In FIG. 2, transmitter 108 of system 100 of FIG. 1 has been assigned slots in each frame to transmit data bursts 214, 216, 218, 220. Four input packets 222, 224, 226 and 228 are all assigned to be transmitted in their next available burst, so input packet 222 is assigned data burst 216, input packets 222 and 224 are both assigned to data burst 218 and input packet 226 is assigned to data burst 220. Thus, FIG. 2 illustrates that input data packets arriving at regular 20 ms intervals are subsequently transmitted at irregular intervals. Input packets 222, 224, 226 and 228 arriving at intervals 20 ms, 20 ms, 20 ms are transmitted as data packets 230, 232, 234, and 236 with intervals 45 ms, 0 ms, 45 ms. The differences in intervals of 25 ms, 20 ms and 25 ms are the packet to packet jitter introduced by the TDMA slot assignments process.

The 45 ms, 0 ms, 45 ms intervals are maintained across the satellite link and appear at the input of jitter buffer 124 of system 100 of FIG. 1. Data packets enter jitter buffer 124 of system 100 as they arrive at irregular intervals. However, jitter buffer 124 has been configured to output packets at the original packet rate which is at regular 20 ms intervals. Thus, the jitter is removed by jitter buffer 124. Note that the original packet rate must be known in order to configure jitter buffer 124. In other examples, TDMA frames may be longer or shorter than 45 milliseconds and TDMA bursts can be elsewhere in the TDMA frame than that shown in FIG. 2. The effects of a jitter buffer on the slot-assigned packet streams of diagram 200 of FIG. 2 can be illustrated by following the packet stream paths through the components of system 100 of FIG. 1.

FIG. 3 illustrates a block diagram 300 depicting transmission of the packet stream of FIG. 2 within the system of FIG. 1, in accordance with example embodiments. As shown in FIG. 3, a packet stream 302 is input to TDMA slot assigner 104. A slot-assigned data stream 304 is output from TDMA slot assigner 104 to transmitter 108. A packet stream 306 is generated by receiver 120. A buffer output data stream 308 is output from jitter buffer 124. In the figure, slot assigner 104, transmitter 108, transmission antenna 112, satellite 114, receive antenna 116, receiver 118 and jitter buffer 120 perform the same functions as in system 100 of FIG. 1. Further, FIG. 3 illustrates the packet streams and timing described by FIG. 2 applied to the functions of FIG. 1. Packet stream 302 is the equivalent of input packets 222, 224, 226 and 228 which are regularly spaced in time. Slot-assigned data stream 304 contains packets 230, 232, 234, and 236 which have the irregular timing caused by TDMA slot assignment. Packet stream 306 inherits the irregular timing of slot-assigned data stream 304 at the receiving end of the link. The packets of buffer output data stream 308 are regular after having had the jitter removed by jitter buffer 120.

FIG. 4 illustrates an example transmission timing diagram of the system of FIG. 1 for a packet stream wherein data packets are arriving at irregular intervals. As shown in FIG. 4, diagram 400 includes X-axis 202, Y axis 204, TDMA frame 206, TDMA frame 208, TDMA frame 210, TDMA frame 212, TDMA data burst 214, TDMA data burst 216, TDMA burst 218, TDMA burst 220, an input packet 402, and input packet 404, an input packet 406, an input packet 408, an output packet 410, an output packet 412, an output packet 414 and an output packet 416. In FIG. 4, as in FIG. 2, transmitter 108 of system 100 of FIG. 1 has been assigned slots in each frame to transmit data bursts 214, 216, 218, 220. Also in FIG. 4, and in a similar manner to FIG. 2, four input packets 402, 404, 406 and 408 are all assigned to be transmitted in their next available burst, so input packet 402 is assigned data burst 216, input packets 404 and 406 are both assigned to data burst 218 and input packet 408 is assigned to data burst 220. Note that, unlike FIG. 2, the input packets 402, 404, 406 and 408 are irregular, arriving at intervals of 20 ms, 30 ms and 40 ms. Note also that these are transmitted as data packets 410, 412, 414, 416 with intervals 45 ms, 0 ms, 45 ms which are the same intervals as the transmitted packets of FIG. 2. The packet to packet jitter in this case is 25 ms, 30 ms and 5 ms.

One example of an irregular packet stream is one that is inherently irregular. In this case, the packet stream may be deliberately irregular according to the application sourcing the data. One such application is a Global System for Mobile (GSM) backhaul. Another example of an irregular packet stream is one whereby a plurality of regular packet streams is presented to the system as a combined stream where the individual streams cannot be distinguished at the receiving end of the link due to a variety of reasons such as the inability to decrypt the packet headers. Examples can be illustrated in a diagram.

FIG. 5 illustrates a diagram of irregular data packet streams presented for transmission over an end-to-end TDMA satellite path, in accordance with example embodiments. As shown in FIG. 5, the diagram 500 includes a single inherently irregular packet stream 502, a regular packet stream 504, a regular packet stream with a different regularity 506 and an irregular packet stream 508. In the figure it is arranged for multiple regular packet streams, in this case 504 and 506, to arrive simultaneously and combine and so present to a system of FIG. 1 an effective irregular packet stream 508 for transmission over the system.

It has already been described that for regular packet streams jitter is introduced at the transmission end of the communications link by the TDMA slot assignment process and that the jitter can be mitigated at the reception end of the communications link by a jitter buffer. For irregular packet streams, however, a conventional approach to jitter buffers fails to mitigate the resulting jitter. With a conventional approach, in situations where the original packet stream is regular, the jitter buffer would be configured to output the packets at regular intervals. In situations where the original packet stream is irregular, however, the jitter buffer would attempt to remove jitter caused by TDMA slot assignment, still outputting the packets at regular intervals, and would thus output the packets incorrectly due to the further jitter introduced by the irregularity of the stream. As is further evident, such an approach may in fact introduce additional jitter by attempting to generate a regular packet stream from an irregular source.

In accordance with example embodiments of the present invention, an approach is provided whereby the jitter in a TDMA system is mitigated or eliminated in situations where the jitter caused by the assigning and inserting of data packets for transmission in TDMA time slots, where those data packets do not arrive at regular intervals. It does this by uniquely accounting for the delays in packet transmission, which cause jitter at the transmit end of the TDMA communications link, and sending the delay information across the link to the receiving end. At the receiving end a jitter buffer uses the received delay information to attempt to recreate as closely as possible the original irregular spacing of packets arriving at the transmit side, thus reducing, and in some cases eliminating, jitter. A system and method in accordance with aspects of the present invention measures the delay from a packet's arrival to the time it is transmitted in a TDMA time slot. This measurement is made for each and every packet requiring jitter reduction and the values are sent, along with their corresponding packets, to the receiving end of the TDMA communications link. Here the delay values are used to calculate the length of time each packet should be retained in the jitter buffer before being output. The output of the unique jitter buffer thus provides packet timing which is the same as, or very close to, the original irregular packet timing before packet jitter was introduced.

In accordance with example embodiments, approaches are provided that facilitate the elimination of jitter as opposed to just reducing it. Such approaches, however, may come at the expense of a longer jitter buffer retention time, which may introduce more latency. Latency is the end-to-end delay of packets across the communications link, which can be undesirable in some applications, especially voice applications where both packet jitter and latency can adversely affect perceived voice quality. In such applications, in accordance with further example embodiments, approaches are provided that employ a mechanism to allow the amount of latency to be traded off against the amount of jitter reduction in order to “tune” the communications link for best achievable voice quality. This is done using a controllable reference delay parameter, which effectively skews jitter buffer retention times away from the ideal values needed for zero jitter such that latency is reduced.

Accordingly, the systems and methods in accordance with example embodiments are therefore uniquely able to mitigate or eliminate jitter in applications involving irregular packet data streams (where conventional approaches would not achieve the desired results, and could in fact actually worsen the jitter), while also providing for mitigation or elimination of jitter in applications involving regular packet data streams.

FIG. 6 illustrates a block diagram of a transmission system, in accordance with example embodiments. Also, FIG. 12A illustrates a flow chart of the transmission side of a method for employing an approach for mitigating or eliminating jitter 1210, in accordance with example embodiments. With reference to FIG. 6, system 600 comprises a the transmitter 108, a TDMA slot assigner 104 and a packet delay timer 606. The transmitter 108, TDMA slot assigner 104 and packet delay timer 606 represent components of the terminal transmission section 101 of a satellite terminal at the transmission end of the system 600. Slot assigner 104 is arranged to receive the packet stream 602 (Step 1211 of FIG. 12A) and output slot-assigned packet stream 106 (Step 1215 of FIG. 12A). Transmitter 108 is arranged to input slot-assigned packet stream 106 and packet delay value 608 and to generate a transmission signal including the slot-assigned packets and the respective packet delay values (e.g., RF signal 604) (Step 1217 of FIG. 12A). Transmission antenna 112 is arranged to transmit the transmission signal to the satellite 114 over the uplink channel 130 (Step 1219 of FIG. 12A). Packet delay timer 606 is arranged to input each packet from packet stream 602 and from slot-assigned packet stream 106, or to receive an indication as to when each packet is received by the terminal (e.g., received at the TDMA slot assigner 104) and when the respective packet is placed and allocated time slot for transmission, and to determine and output a respective packet delay value 608 (Step 1213 of FIG. 12A). For example, the packet delay value comprises a measurement of the delay between the time the packet is received by the terminal (e.g., received at the TDMA slot assigner) and the time the packet is placed in an allocated slot for transmission. The packet delay value thereby measures a delay factor that each packet experiences at the transmission end, for provision to the receiver end in order for the receiver to factor that delay into the mechanism for mitigating the jitter.

TDMA slot assigner 104 assigns packets of packet stream 602 to TDMA time slots in the TDMA frame and inserts the packets of packet stream 602 in the assigned TDMA time slots to produce slot-assigned packet stream 106. Transmitter 108 converts slot-assigned packet stream 106 to radio frequencies to produce RF signal 604. RF signal 604 is transmitted over-the-air by transmission antenna 112. For each packet in packet stream 602, packet delay timer 606 measures the time delay to the equivalent packet in slot-assigned packet stream 106. Packet delay timer 606 produces a delay value 608 for each packet it measures and these values are input to transmitter 108 along with slot assigned packet stream 106 and appear in RF signal 604. Further, according to the illustrated embodiments, transmitter 108 and transmission antenna 112 are shown to be a satellite link transmitter and a satellite dish respectively, but in some embodiments these may be any components used to transmit a packet stream to a far receiving station including, but not limited to, a cellular transmitter and antenna, a WiFi or Bluetooth transmitter and antenna, a terrestrial microwave link transmitter and antenna or a device for wired telecommunications transmission.

Moreover, according to the described embodiments, all packets for transmission require jitter removal and all are treated the same way. In other embodiments, however, it may be desired that some packets will require jitter reduction, but depending on application, others may not. These may be uniquely identified by various methods including, but not limited to, separation by stream or by flagging for different treatment on a packet by packet basis.

FIG. 7 illustrates a block diagram of a receiving system, in accordance with example embodiments. Also, FIG. 12B illustrates a flow chart of the receiver side of a method for employing an approach for mitigating or eliminating jitter 1220, in accordance with example embodiments. With reference to FIG. 7, system 700 includes receiving antenna 116, a receiver 120, a jitter buffer 710, a reference delay parameter register 714, a processor 718 and a comparator 720. The receiver 120, jitter buffer 710, reference delay parameter register 714, processor 718 and comparator 720 represent components of the terminal receiver section 111 of a satellite terminal at the receiver end of the system 700. The receiving antenna 102 is arranged to receive downlink transmission signals from the satellite 114 over the downlink channel 132 (e.g., the transmission signals transmitted by the terminal transmission section 101 to the satellite over the uplink channel) and output an RF signal on 118 to receiver 120. The receiver 120 receives the transmission signals, including the plurality of data packets and the respective packet delay values (Step 1221 of FIG. 12B), and is arranged to output packet stream 706 and packet delay values 708. Each packet for which jitter mitigation is to be applied (each packet that is associated with a delay factor) is queued in the jitter buffer 710 (Step 1223 of FIG. 12B). The jitter buffer 710 is arranged to receive packet stream 706, and packet retention time values from processor output 724 and output packet stream 712. Reference delay parameter register 714 stores one or more predetermined reference latency parameters or reference delay parameters, and is arranged to output reference delay parameters 716. Processor 718 is arranged to input packet delay values 708, reference delay parameters 716 and output packet retention time values on processor output 724.

According to example embodiments, the receiving antenna 116 converts over-the-air signals to an RF signal compatible with receiver 120. Receiver 120 extracts the data packet stream and packet delay values from RF signal 118. Jitter buffer 710 inputs the packets of packet stream 706 and outputs them in a manner which reduces or removes jitter. Reference delay parameter register 714 holds the reference delay parameters. For each packet of packet stream 706, processor 718 subtracts packet delay value 708 from reference delay parameter 716 to produce a buffer retention time value for that packet. For each packet of packet stream 706, comparator 720 compares packet delay value 708 with reference delay parameter 716 (Step 1225 of FIG. 12B). The jitter buffer 710 then releases each queued packet based on the result of the comparison (Step 1227 of FIG. 12B). By way of example, as a result of the comparison, the comparator 720 may produce comparator output signal 722 in one of two states. One of the two states would correspond to a situation where packet delay value 708 is greater or equal to reference delay parameter 716, and the other state would correspond to a situation where packet delay value 708 is less than reference delay parameter 716. For the result where packet delay value 708 is greater or equal to the reference delay parameter 716, the processor output 724, and therefore the packet retention value, is forced to zero—in which case the respective packet would either not be queued or would be promptly or immediately released from the jitter buffer. For the result where packet delay value 708 is less than the reference delay parameter 716, the processor output 724, and therefore the packet retention value, is set based on that difference—in which case the respective packet would be queued in the jitter buffer and released based on the comparison value.

Accordingly, the received side jitter buffer approach is configured based on the delay of packets at the transmission side, as measured by the transmitter section 101 and provided to the receiver section 111. For example, the queued packets are released from the jitter buffer based on a timestamp, calculated based on the measured TDMA packet delay at the transmitter and a parameter that determines a minimum value for how long the respective packet remains queued in the jitter buffer. The parameter (e.g., the reference delay parameter) may either be predetermined (e.g., based on the physical frame length) and configured in the receiver section, or trained based on system operation and the maximum TDMA packet delay experienced by the packets. For example, the parameter may be set such that it is some milliseconds less than the maximum delay experienced by a packet. Thus, when a packet has experienced a TDMA latency at the transmitter of more than or equal to this parameter, is released from the jitter buffer immediately. On the other hand, when a packet has experienced a latency at the transmitter that is less than this parameter, the packet remains in the jitter buffer for time period calculated as the difference between the reference delay parameter and the TDMA latency measured at the transmitter (the packet delay value).

According to example embodiments, the calculation made using processor 718 and comparator 720 reduces the overall buffer retention times from those needed to achieve zero jitter. This allows some jitter to make it through the system. However, as packets remain in the jitter buffer for less time, it also reduces latency. The reference delay parameter 716 in the reference delay parameter register 714 can be changed. Thus latency can be traded off against jitter to different degrees and the link can be “tuned” for different applications. For example, for an application for which latency is not an issue, the link can be tuned for minimum jitter. As another example, for a voice application where the voice quality would be adversely (but differently) affected by both jitter and latency, the reference delay parameter can be more finely tuned to achieve best voice quality as perceived or as measured.

According to further example embodiments, the tuning or training process may be a manual adjustment of the reference delay parameter adjustment from a local or remote location, or an automatic process. Non-limiting examples of an automatic process may include monitoring actual packet delays, latencies and other link parameters for the system and using these to “train” the network by making ever finer adjustments to the reference delay parameters as more information is gathered. An automatic process may also include monitoring actual packet delays, latencies and other link parameters for the system and using these to re-tune the reference delay parameters as a reaction to changes in the network over time.

Moreover, the jitter buffer at the receiver end may be operated either on a per data stream basis (e.g., multiple data streams may be processed through a single terminal transmission section), or may be operated on a per terminal basis (e.g., when multiple streams through the transmitter section of a terminal cannot be individually identified and processed).

As illustrated in FIG. 7, receiving antenna 116 and receiver 120 are shown to be a satellite dish and a satellite link receiver respectively, but in some embodiments may be any components used to receive a packet stream from any known type of transmitting station, non-limiting examples of which include, a cellular receiver and antenna, a WiFi or Bluetooth receiver and antenna, a terrestrial microwave link receiver and antenna or a device for wired telecommunications reception.

FIG. 8 illustrates a transmission timing diagram for an irregular data packet stream presented to the system of FIG. 6, in accordance with example embodiments. The timing diagram of FIG. 8 further illustrates the temporal relationship between the packets of an irregular packet stream, the TDMA burst and time slots assigned to the packets and measure of packet delay values. With reference to FIG. 8, the x-axis 202 reflects time, and the y-axis 204 reflects the point at time zero. TDMA frames 1-4 (206, 208, 210, 212) reflect sequential TDMA frames being sequentially formed over time, where each frame is 45 ms in length. Slots 214, 216, 218, 220 reflect burst slots within the respective TDMA frames 1-4 for transmission of respective data packets. For example, the slots may be allocated to the transmission section 101 for data packets received by the terminal. The packets P1-P4 (802, 804, 806, 808) reflect packets of an input data stream received by the transmission section 101, which are received at irregular intervals. By way of example, packet P1 is received during the formation of TDMA frame 1, packet P2 is received 30 ms later during the formation of TDMA frame 2, and packet P3 is received 20 ms later still during the formation of TDMA frame 2 and packet P4 is received 40 ms later during the formation of TDMA frame 3. As is evident from FIG. 8, the first transmission opportunity for respective packet is within the next allocated slot after the packet is received. Accordingly, the next transmission opportunity for packet P1 is within the allocated slot 216, the next transmission opportunity for packets P2 and P3 is within the allocated slot 218, and the next transmission opportunity for packet P4 is within the allocated slot 220. As is further evident from FIG. 8, the packet delay value from the receipt of packet P1 to the placement within slot 216 is 20 ms, the packet delay value from the receipt of packet P2 to the placement within slot 218 is 40 ms, the packet delay value from the receipt of packet P3 to the placement within slot 218 is 20 ms, and the packet delay value from the receipt of packet P4 to the placement within slot 220 is 35 ms. Also, it should be noted that packets P2 and P3, although received at different times, are transmitted together using the same time slot 218.

Referring to the example of FIG. 8, first, the reference delay or latency parameter (at the receive end) is set to 35 ms. Then, considering the packet P1, the respective packet delay value is measured at 20 ms and is provided to the receiver section 111. Based on this, the comparator will determine that the difference between the measured packet delay value and the reference delay parameter is 15 ms (35 ms-20 ms), and the packet will thus be queued in the jitter buffer for 15 ms. With respect to packet P2, the comparator will determine that the difference between the measured packet delay value (40 ms) and the reference delay parameter is −5 ms (35 ms-40 ms)—the measured packet delay value is greater than the reference delay parameter. The packet P2 will thus be released from the jitter buffer immediately. With respect to packet P3, the comparator will determine that the difference between the measured packet delay value and the reference delay parameter is 15 ms (35 ms-20 ms), and the packet will thus be queued in the jitter buffer for 15 ms. Finally, for packet P4, the comparator will determine that the difference between the measured packet delay value and the reference delay parameter is 0 ms (35 ms-35 ms), and thus the packet will be released from the jitter buffer immediately. Accordingly, without the jitter buffer, the maximum packet to packet TDMA jitter would have been 20 ms (between packet P1 and P2, because the TDMA latencies of P1 and P2 are 20 ms and 40 ms, respectively). In accordance with the illustrated example of the present invention, however, the maximum packet to packet jitter will be only 5 ms. This is because the total latency for packets P1, P3 and P4 amounts to 35 ms (the aggregate of the measured packet delay from transmission end and the delay while queued in the jitter buffer), and packet P2 maintains its original 40 ms TDMA latency from the transmission end (no additional delay is added by the jitter buffer). Alternatively, if the reference delay parameter was set to 45 ms, then the resulting TDMA jitter would have been zero. Moreover, for example, with a 45 ms TDMA frame and a 45 ms reference delay parameter, the maximum time a packet must wait to be transmitted is when it just misses a burst on arrival and must wait an entire frame before transmission in the next burst, and thus the maximum packet delay value for a 45 ms TDMA frame would also be 45 ms.

FIG. 9 provides a table illustrating arrival times and intervals between packets of an irregular packet stream measured at various points in the systems of FIGS. 6 and 7, with a reference delay parameter set to equal a frame period of 45 milliseconds, in accordance with example embodiments. Column 904 of Table 900 shows the arrival times of input packets 802, 804, 806 and 808 of diagram 800 and column 906 shows the intervals between packets of 20 ms, 30 ms and 40 ms. This is clearly an irregular packet stream, the intervals of which a jitter buffer would not have been able to process correctly. For purposes of discussion, as shown in column 904, input packet 802, the first packet, arrives at time=zero. Column 908 shows the time of transmission of output packets 810, 812, 814 and 816, whereas column 910 shows the intervals between those packets. It should be noted that the 45 ms, 0 ms, 45 ms spacing is due to the TDMA slot assignment function and the difference in spacing between column 910 and column 906 represents the jitter that has been introduced by the TDMA slot assignment function.

Column 912 shows the measured packet delay values for input packets 802, 804, 806 and 808 and column 914 shows the buffer retention values for each packet as derived for the case where the reference delay parameter is set to 45 ms. The buffer retention values are calculated by subtracting each of the measured packet delay values of column 912 from the reference delay parameter of 45 ms, according to the aspects of the invention. Note that packet P2 of column 902 does not spend any time in the jitter buffer 710 of system 700 since its measured packet delay value meets the criteria of being the same or greater than the reference delay parameter.

Column 918 shows the time of arrival of packets at jitter buffer 710 of system 700 as normalized to a first packet arrival time of zero. It should be noted that these correspond to the intervals between transmission of column 910, which contains the jitter introduced by the TDMA slot assignment function. Column 920 shows the times at which packets are released from jitter buffer 710, according to buffer retention times calculated according to the aspects of the invention. Column 922 shows the intervals between those packets. It should be noted that these intervals are the same as those of the input packets 802, 804, 806 and 808 from column 906 and so the irregular packet stream timing has been successfully processed by the present invention. Finally, as shown in column 924, the packet to packet jitter is calculated. It should be noted that this is zero, indicating that the jitter introduced by the TDMA slot assignment process has been eliminated in this case.

Table 900 illustrates that for a reference delay parameter that equals the maximum packet delay value, the intervals between input packets at the transmission end of the link are maintained at the output of the jitter buffer at the receiving end of the link, and that the jitter is zero. This is also true if the reference delay parameter is greater than the maximum packet delay value. It should be noted, however, that the packets have remained in the jitter buffer for 25 ms, 0 ms, 30 ms and 25 ms respectively and these times would have been even larger if the reference delay parameter were set to be greater than 45 ms. The durations spent in the jitter buffer add to the overall packet latency across the communications link, which can also be undesirable for some applications. Further, as discussed earlier, one aspect of the invention is to be able to reduce packet latency at the expense of allowing some amount of jitter to remain where this is advantageous for a particular application such as a voice application. This is done by setting the reference delay parameter to be less than the maximum packet delay value.

FIG. 10 provides a table illustrating arrival times and intervals between packets of an irregular packet stream measured at various points in the systems of FIGS. 6 and 7, for example, with a reference delay parameter set at 40 milliseconds, which is 5 ms less than the maximum jitter value, in accordance with example embodiments. Column 1004 of Table 1000 shows the arrival times of input packets 802, 804, 806 and 808 of diagram 800 and column 1006 the intervals between packets of 20 ms, 30 ms and 40 ms. This is clearly an irregular packet stream, the intervals of which a jitter buffer would not have been able to process correctly. For purposes of discussion, as shown in column 1004, input packet 802, the first packet, arrives at time=zero. Column 1008 shows the time of transmission of output packets 810, 812, 814 and 816, whereas column 1010 shows the intervals between those packets. It should be noted that the 45 ms, 0 ms, 45 ms spacing is due to the TDMA slot assignment function and the difference in spacing between column 1010 and column 1006 represents the jitter that has been introduced by the TDMA slot assignment function.

Column 1012 shows the measured packet delay values for input packets 802, 804, 806 and 808 and column 1014 shows the buffer retention values for each packet as derived for the case where the reference delay parameter is set to 40 ms. The buffer retention values are calculated by subtracting each of the measured packet delay values of column 1012 from the reference delay parameter of 45 ms, according to the aspects of the invention. Note that packet P2 of column 1002 does not spend any time in the jitter buffer 710 of system 700 since its measured packet delay value meets the criteria of being the same or greater than the reference delay parameter.

Column 1018 shows the time of arrival of packets at jitter buffer 710 of system 700 as normalized to a first packet arrival time of zero. It should be noted that these correspond to the intervals between transmission of column 1010 which contains the jitter introduced by the TDMA slot assignment function.

Column 1020 shows the times at which packets are released from jitter buffer 710, due to buffer retention times calculated according to the aspects of the invention. Column 1022 shows the intervals between those packets. It should be noted that, since in this example while these intervals are not the same as those of the input packets 802, 804, 806 and 808 from column 1006, they are close. This is consistent with the case being described, whereby an amount of jitter has been allowed to remain in order to reduce latency and so it can be said that the irregular packet stream timing has been successfully processed by the present invention. Finally, as shown in column 1024, the packet to packet jitter is calculated. It should be noted that the packet jitter is not zero as is consistent with the case being described whereby an amount of jitter has been allowed to remain in order to reduce latency.

The jitter introduced by the TDMA slot assignment process is the difference between the arrival intervals at the buffer input in column 1018 and the arrivals at the slot assigner in column 1004. In this case, the maximum amount of jitter between any two packets introduced by the TDMA slot assignment process is for P1 and P2 of column 1002 and the value is 25 ms. The maximum amount of jitter after the jitter reduction process as shown in column 1024 is 5 ms. So, while some jitter has been allowed to remain in this case, it has been successfully reduced in accordance with aspects of the invention.

Table 1000 illustrates that for a reference delay parameter which is less than the maximum packet delay value, the packet to packet jitter is reduced but some still remains. The buffer retention times, however, when compared with the case in Table 900 have decreased to from 25 ms, 0 ms, 30 ms and 25 ms respectively to 20 ms, 0 ms, 25 ms and 20 ms respectively, a decrease of 5 ms for those packets which were retained. In this case, a 5 ms decrease in jitter buffer retention would translate directly to a 5 ms decrease in packet latency across the link. Table 1000 shows, therefore, a “link tuning” case where a 5 ms improvement in latency has been traded off against a 5 ms increase in jitter.

In alternative embodiments, the reference delay parameter may be configurable or it may be trained to allow tuning of the communication links for different applications or for changes over time. Another embodiment using a trained reference delay parameter adjustments may be one in which some parameters, non-limiting examples of which include maximum TDMA packet delays values, are monitored over time by a known training algorithm that adjustment reference delay parameters in order to maintain optimum amounts of jitter and latency.

It should be noted that although the input packet streams for FIGS. 8-10 are irregular, these non-limiting examples are provided to merely illustrate a condition where the present invention is an improvement on the jitter buffer. Irregularity of the input packet stream is not a requirement for a system in accordance with aspects of the present invention. As such, a system in accordance with aspects of the present invention may perform identically on regular packet streams. The packet delays and buffer retention times may be measured, calculated and applied in the same way and the jitter will be reduced or eliminated accordingly. It should also be noted that for regular packet streams, a system in accordance with aspects of the present invention provides an improvement on a jitter buffer due to capability to allow adjustments of jitter versus latency through the adjustability of the reference delay parameter.

In order to more easily explain the principles of the present invention, a system which includes a single jitter buffer has been described. However, other embodiments in accordance with aspects of the present invention may include a plurality of jitter buffers. A plurality of jitter buffers may be used for different reasons, non-limiting examples of which include, for use with multiple data ports, multiple packet streams, multiple terminals and multiple reference delay parameters.

FIG. 11 illustrates a block diagram depicting a multiple jitter buffer system, employing two jitter buffers on the basis of multiple reference delay parameters, in accordance with example embodiments. As shown in the figure, system 1100 of FIG. 11 includes receiving antenna 116, receiver 120, jitter buffer 710, reference delay parameter register 714, a processor 1106, a jitter buffer 1102, a reference delay parameter register 1108 and a processor 1112. Downlink 132, receiving antenna 116, RF signal 118, receiver 120, packet stream 706, packet delay value 708, jitter buffer 710, packet stream 712, reference delay parameter register 714, reference delay parameter 716 are arranged in the same manner as in system 700 of FIG. 7. Processor 1106 is processor 718, comparator 720 and comparator output 722 of system 700 combined as a unitary component. Processor 1112 similarly arranged to include a comparator function. Reference delay parameter register 1108, reference delay parameter 1110, processor 1112, processor output 1114, jitter buffer 1102 and packet stream 1104 form an additional jitter buffer function arranged in the same manner as reference delay parameter register 714, reference delay parameter 716, a processor 1106, processor output 724, jitter buffer 1102 and packet stream 1104.

System 1100 operates using aspects of the present invention and illustrates an example embodiment with two independent jitter buffers 710 and 1102 which employ independent reference delay registers 714 and 1108. Jitter buffer 710 which uses a reference delay parameter of 45 ms would be used for a transmitted packet stream belonging to an application which requires minimum jitter for best operation since, as illustrated by Table 900, it will eliminate jitter at the expense of higher packet latency. On the other hand, jitter buffer 1102, as illustrated by Table 1000, would be used when the transmitted packet stream is associated with an application which can tolerate some packet jitter and is more sensitive to packet latency.

A problem with a TDMA jitter buffer mechanism is that it is suitable only for regular packet streams and will not work for irregular packet streams. The foregoing descriptions illustrate and explain how a system and method in accordance with aspects of the present invention overcomes this problem by employing a mechanism that accounts for the irregular amounts of packet jitter produced at transmission over a TDMA system. It has also been described how this accounting is used at the receiving terminal to control the rates at which packets leave one or more unique jitter buffers such that the packet jitter is reduced or eliminated. It has been shown that a system and method in accordance with aspects of the present invention may support regular as well as irregular packet streams. Additionally, it has been described that the mechanism may incorporate an adjustable parameter, which allows packet jitter to be traded off against end to end packet latency allowing the system to be adjusted or “tuned” manually or automatically to cater for different applications or for system changes over time.

FIG. 13 illustrates a block diagram depicting of a chip set that can be utilized in implementing an approach for mitigating or eliminating jitter, in accordance with example embodiments. With reference to FIG. 13, chip set 1300 includes, for instance, processor and memory components, such as described with respect to FIGS. 7 and 11, incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1300 includes a communication mechanism such as a bus 1301 for passing information among the components of the chip set. A processor 1303 has connectivity to the bus 1301 to execute instructions and process information stored in, for example, a memory 1305. The processor 1303 includes one or more processing cores with each core configured to perform independently. A multi-core processor enables multiprocessing within a single physical package. Examples of a multi-core processor include two, four, eight, or greater numbers of processing cores. Alternatively or in addition, the processor 503 includes one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, and/or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 may comprise various forms of computer-readable media, e.g., including both dynamic memory (e.g., RAM) and static memory (e.g., ROM) for storing executable instructions that, when executed by the processor 1303 and/or the DSP 1307 and/or the ASIC 1309, perform the process of example embodiments as described herein. The memory 1305 also stores the data associated with or generated by the execution of the process.

The term “computer-readable medium” or “computer-readable media,” as used herein, refers to any medium that participates in providing instructions for execution by the processor 1303, and/or one or more of the specialized components, such as the one or more digital signal processors (DSP) 1307, and/or one or more application-specific integrated circuits (ASIC) 1309. Such a medium may take many forms, including but not limited to non-volatile media, volatile media, and transmission media. Non-volatile media include, for example, read only memory (ROM), included within memory 1305. Volatile media, for example, may include dynamic random access memory (RAM), included within memory 1305. Transmission media may include copper or other conductive wiring, fiber optics, or other physical transmission media, including the wires and/or optical fiber that comprise bus 1301. Transmission media can also take the form of wireless data signals, such as those generated during radio frequency (RF) and infrared (IR) data communications. Common forms of computer-readable media include, for example, magnetic storage media (e.g., magnetic hard disks or any other magnetic storage medium), solid state or semiconductor storage media (e.g., RAM, PROM, EPROM, FLASH EPROM, a data storage device that uses integrated circuit assemblies as memory to store data persistently, or any other storage memory chip or module), optical storage media (e.g., CD ROM, CDRW, DVD, or any other optical storage medium), a or any other medium for storing data from which a computer or processor can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Moreover, as will be appreciated, a module or component (as referred to herein) may be composed of software component(s), which are stored in a memory or other computer-readable storage medium, and executed by one or more processors or CPUs of the respective devices. As will also be appreciated, however, a module may alternatively be composed of hardware component(s) or firmware component(s), or a combination of hardware, firmware and/or software components. Further, with respect to the various example embodiments described herein, while certain of the functions are described as being performed by certain components or modules (or combinations thereof), such descriptions are provided as examples and are thus not intended to be limiting. Accordingly, any such functions may be envisioned as being performed by other components or modules (or combinations thereof), without departing from the spirit and general scope of the present invention.

While example embodiments of the present invention may provide for various implementations (e.g., including hardware, firmware and/or software components), and, unless stated otherwise, all functions are performed by a CPU or a processor executing computer executable program code stored in a non-transitory memory or computer-readable storage medium, the various components can be implemented in different configurations of hardware, firmware, software, and/or a combination thereof. Except as otherwise disclosed herein, the various components shown in outline or in block form in the figures are individually well known and their internal construction and operation are not critical either to the making or using of this invention or to a description of the best mode thereof.

In the preceding specification, various embodiments have been described with reference to the accompanying drawings. It will, however, be evident that various modifications may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
a receiver configured to receive a data transmission signal via a channel of a communications system, wherein the received data transmission signal includes a plurality of data packets, and to receive one or more delay factors measured at a transmission end of the channel, wherein each delay factor is associated with a respective one of the data packets;
a processor configured to queue each of the data packets that is associated with a delay factor in a respective one of one or more jitter buffers; and
a comparator configured to perform a comparison, for each data packet that is associated with a delay factor, between the respective delay factor and a predetermined latency parameter;
wherein the processor is further configured to release each data packet that is queued in one of the jitter buffers based on the comparison between the respective delay factor associated with the data packet and the predetermined latency parameter.

2. The apparatus of claim 1, wherein each delay factor comprises a delay measurement based on a time that the respective data packet is received by a transmitter at the transmission end of the channel, and a time that the respective data packet is transmitted over the channel.

3. The apparatus of claim 2, wherein the predetermined latency parameter comprises a delay value reflecting an approximate maximum acceptable latency for the data packets queued in the one or more jitter buffers, and wherein the processor releases each queued data packet in accordance with a timestamp, wherein the timestamp is determined based on the comparison such that a total time that the packet remains in the jitter buffer plus the respective delay factor does not exceed the approximate maximum acceptable latency for the data packet.

4. The apparatus of claim 3, wherein the predetermined latency parameter comprises one of a configurable system parameter set based on a length of a transmission frame and a trained parameter that is determined based on a relative maximum data packet delay experienced during a period of system operation.

5. The apparatus of claim 4, wherein the system comprises a time division multiple access (TDMA) system, and the data packets are multiplexed within time slots of the transmission frame.

6. The apparatus of claim 5, wherein the communications system comprises a multi-frequency TDMA satellite system.

7. The apparatus of claim 1, wherein the predetermined latency parameter comprises a delay value reflecting an approximate maximum acceptable latency for the data packets queued in the one or more jitter buffers.

8. The apparatus of claim 1, wherein the predetermined latency parameter comprises one of a configurable system parameter set based on a length of a transmission frame and a trained parameter that is determined based on a relative maximum data packet delay experienced during a period of system operation.

9. The apparatus of claim 1, wherein the processor is further configured to utilize the one or more jitter buffers, respectively, for one or more of queuing data packets on a source data stream basis, wherein each jitter buffer queues data packets from a respective source data stream from a transmission end of the channel, and queuing data packets on a transmitter basis, wherein each jitter buffer queues data packets transmitted by a respective source transmitter at the transmission end of the channel.

10. A method, comprising:
receiving, by a receiver of a device, a data transmission signal over a channel of a communications system, wherein the received data transmission signal includes a plurality of data packets;
receiving one or more delay factors measured at a transmission end of the channel, wherein each delay factor is associated with a respective one of the data packets;
queuing each of the data packets that is associated with a delay factor in a respective one of one or more jitter buffers;
performing a comparison for each data packet that is associated with a delay factor, between the respective delay factor and a predetermined latency parameter; and
releasing each data packet that is queued in one of the jitter buffers based on the comparison between the respective delay factor associated with the data packet and the predetermined latency parameter.

11. The method of claim 10, wherein each delay factor comprises a delay measurement based on a time that the respective data packet is received by a transmitter at the transmission end of the channel, and a time that the respective data packet is transmitted over the channel.

12. The method of claim 11, wherein:
the predetermined latency parameter comprises a delay value reflecting an approximate maximum acceptable latency for the data packets queued in the one or more jitter buffers;
the releasing of each data packet that is queued in one of the jitter buffers comprises releasing each queued data packet in accordance with a timestamp, and
wherein the timestamp is determined based on the comparison such that a total time that the packet remains in the jitter buffer plus the respective delay factor does not exceed the approximate maximum acceptable latency for the data packet.

13. The method of claim 12, wherein the comparison for each data packet that is associated with a delay factor comprises performing the comparison such that the predetermined latency parameter comprises one of a configurable system parameter set based on a length of a transmission frame and a trained parameter that is determined based on a relative maximum data packet delay experienced during a period of system operation.

14. The method of claim 13, wherein the communication system comprises a time division multiple access (TDMA) system, and the data packets are multiplexed within time slots of the transmission frame.

15. The method of claim 14, wherein the communication system comprises a multi-frequency TDMA satellite system.

16. The method of claim 10, wherein the predetermined latency parameter comprises a delay value reflecting an approximate maximum acceptable latency for the data packets queued in the one or more jitter buffers.

17. The method of claim 10, wherein the predetermined latency parameter comprises one of a configurable system parameter set based on a length of a transmission frame and a trained parameter that is determined based on a relative maximum data packet delay experienced during a period of system operation.

18. The method of claim 10, further comprising:
utilizing the one or more jitter buffers, respectively, for one or more of queuing data packets on a source data stream basis; and
wherein each jitter buffer queues data packets from a respective source data stream from a transmission end of the channel, and queuing data packets on a transmitter basis; and
wherein each jitter buffer queues data packets transmitted by a respective source transmitter at the transmission end of the channel.
